(19) United States
(12) Patent Application Publication
(10) Pub. No.: US 2026/0264862 A1
(43) Pub. Date: Sep. 10, 2026

(54) SYSTEM AND METHOD FOR TENSIONING A PARACHUTE CLOSING LOOP

(71) Applicant: U.S. Army DEVCOM, Army Research Laboratory, Adelphi, MD (US)

(72) Inventor: Mahdi Al-Husseini, Enterprise, AL (US)

(73) Assignee: U.S. Government, as Represented by Secretary of the Army, Adelphi, MD (US)

(21) Appl. No.: 19/070,947

(22) Filed: Mar. 5, 2025

(51) Int. Cl. B64D 17/38

(52) U.S. Cl. CPC B64D 17/38

(57) ABSTRACT

Systems, apparatus and methods for tensioning a parachute closing loop during packing, the system comprising: an outer housing with an open access port to facilitate the removal of a parachute bridle line after insertion of a closing pin through the tensioned closing loop; a tensioning mechanism for applying tension to the closing loop to pull it through the flaps of a parachute pack tray; and an inner housing with an attachment bar to connect a pull-up cord routed through the closing loop to the tensioning mechanism.

### GOVERNMENT INTEREST

The invention described herein may be manufactured and used by or for the Government of the United States for all governmental purposes without the payment of any royalty.

### FIELD OF THE DISCLOSURE

The present disclosure relates generally to the tensioning of a parachute closing loop during routine packing, and more particularly to the use of a mechanical system designed to facilitate the routing and tensioning of a fabric closing loop through and past the main pack tray flaps such that a closing pin may be easily inserted into the closing loop.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Proper tensioning of a parachute's main closing loop during routine packing of the parachute is critical to the safe deployment and operation of the parachute. Currently, parachutists manually pack their parachute and manually rig the main closing loop in a manner imparting what they believe to be an appropriate amount of tension to the parachute main closing loop.

The main closing loop typically comprises a fabric closing loop routed through and past the main pack tray flaps such that a closing pin may be easily inserted into the closing loop. The closing pin is attached to a bridle line that, when pulled by the parachutist during a jump, causes the removal of the closing pin from the closing loop such that the main pack tray flaps of the parachute may open up, enabling deployment of the parachute during the jump.

The main closing loop is a critical component of the typical parachute system that allows a parachute packer to enclose a deployment bag with an internal main parachute to the parachute container. During Bottom of Container (BOC) deployment operations, the parachutist pulls on a pilot chute handle that connects through a bridle line to a closing pin which is inserted through the main closing loop. By pulling on the pilot chute handle, the parachutist releases the closing pin from the main closing loop, effectively opening the container pack tray and releasing the deployment bag for main canopy deployment.

Per the FAA's Parachute Rigger Handbook, closing the container is one of the final steps of packing a parachute. A pull-up cord or similar is routed through the closing loop and then through the individual grommets of the container main pack tray flaps. The number and orientation of the container pack tray flaps vary based on the parachute system considered. During the routing process, the bridle line to which the closing pin is affixed is itself routed over one or more main pack tray flaps. Tension must be maintained on the pull-up cord throughout the routing process to not lose access to the closing loop through the grommets. Depending on the size of the deployment bag and enclosed main parachute relative to the container main pack tray, significant tension may be required on the pull-up cord. Manual control of the pull-up cord and attempts to orient around the pack tray may result in increased mechanical wear on the closing loop.

### SUMMARY OF THE INVENTION

Various deficiencies in the prior art are addressed below by the disclosed systems, methods and apparatus for tensioning a parachute closing loop during packing, the system comprising: an outer housing with an open access port to facilitate the removal of a parachute bridle line after insertion of a closing pin through the tensioned closing loop; a tensioning mechanism for applying tension to the closing loop to pull it through the flaps of a parachute pack tray; and an inner housing with an attachment bar to connect a pull-up cord routed through the closing loop to the tensioning mechanism.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 illustrates a disassembled parachute pack tray environment and tensioning system, in accordance with an embodiment of the present invention;

FIG. 2 illustrates an assembled parachute pack tray environment and tensioning system, in accordance with an embodiment of the present invention;

FIG. 3 depicts a flowchart illustrating a method of using a motorized tensioning system to route a closing loop through main pack tray flaps, in accordance with an embodiment of the present invention;

FIG. 4 depicts the components of a manually operated tensioning system, in accordance with an embodiment of the present invention; and

FIG. 5 depicts the components of a motorized tensioning system, in accordance with an embodiment of the present invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments, such as seismology and data fusion.

Various embodiments are directed to a system, device, and method configured to induce tension on a pull-up cord such that the main closing loop of a parachute is quickly and efficiently routed through the main pack tray flap grommets while also held upright such that the closing pin may be easily inserted by the packer. In this manner, more consistent and reproduceable tensioning of the main closing loop during packing is provided, thereby increasing safety and speed in the packing of a parachute.

Proper tensioning of a parachute's main closing loop during routine packing of the parachute is critical to the safe deployment and operation of the parachute. Currently, parachutists manually pack their parachute and manually rig the main closing loop in a manner imparting what they believe to be an appropriate amount of tension to the parachute main closing loop.

The main closing loop typically comprises a fabric closing loop routed through and past the main pack tray flaps such that a closing pin may be easily inserted into the closing loop. The closing pin is attached to a bridle line that, when pulled by the parachutist during a jump, causes the removal of the closing pin from the closing loop such that the main pack tray flaps of the parachute may open up, enabling deployment of the parachute during the jump.

The main closing loop is a critical component of the typical parachute system that allows a parachute packer to enclose a deployment bag with an internal main parachute to the parachute container. During Bottom of Container (BOC) deployment operations, the parachutist pulls on a pilot chute handle that connects through a bridle line to a closing pin which is inserted through the main closing loop. By pulling on the pilot chute handle, the parachutist releases the closing pin from the main closing loop, effectively opening the container pack tray and releasing the deployment bag for main canopy deployment.

The use of tensioning systems to aid in the routing of a closing loop through the main pack tray flaps is an unexplored opportunity to significantly reduce time spent packing, mechanical wear on the closing loop, and overall effort on the part of the packer. Various embodiments of the present invention may use any of a wide array of actuators, mechanical/manual and electrical alike, to aid in the parachute packing process, which can quickly become tedious and draining given the number of repetitions a packer might complete in a day.

The embodiments of the present invention discussed in the detailed description and shown in the drawings are not intended to restrict the scope of tensioning system applications, but rather, to illuminate the underpinnings and advantages brought about through variations on the proposed invention. Additional embodiments may be possible.

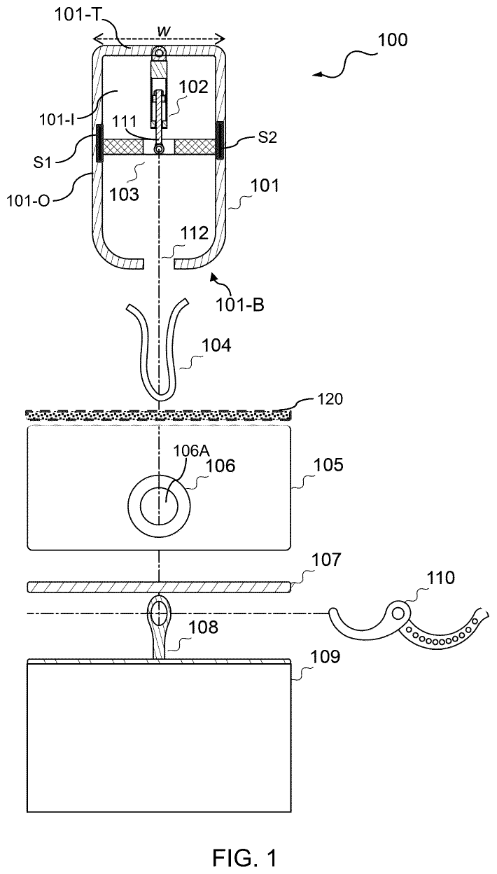

FIG. 1 illustrates a disassembled parachute pack tray environment and tensioning system, in accordance with an embodiment of the present invention. Specifically, FIG. 1 depicts a parachute pack tray environment and tensioning system 100 comprising a rigid or semi-rigid housing 101 having an inner portion 101-I and an outer portion 101-O, the housing 101 optionally having an elongated shape (illustratively cylindrical, though other shapes may be used) with a side to side width w at least slightly larger than an opening or aperture 106A of a top pack tray flap 105, wherein as depicted in FIG. 1 the aperture 106A may be secured via, illustratively, a grommet 106. Housing 101 may be made of any material capable of withstanding the structural tension induced by the tensioning mechanism, such as aluminum, plastic, steel, and/or other materials suitable for this purpose.

Housing 101 comprises a top portion 101-T and a bottom portion 101-B, the bottom portion 101-B having an open access port or aperture 112 defined thereat, the bottom portion 101-B of the outer housing 101 being configured to sit or be disposed upon an upper surface of a top pack tray flap 105 of a parachute container or pack. Open access port 112 allows a parachute bridle line 111 to be routed through the bottom portion 101-B of the outer housing 101, so that outer housing 101 may be removed from atop the parachute container once tensioning is complete.

An inner housing 103 is disposed within the housing 101 and may take the form of a horizontal bar securely connected on both ends to the inner walls of the inner portion 101-I of the housing 101. The inner housing 103 serves as a rigid attachment point for a tensioning mechanism 102 and, when attached thereto, a pull-up cord 104. In some embodiments, inner housing (attachment bar) 103 is formed using the same or similar materials as housing 101, and is configured to slide vertically in first S1 and second S2 slots formed within the inner walls of housing 101 as the tensioning mechanism actuates. As shown in FIG. 1, tensioning mechanism 102 may be motorized in nature, such as a micro-linear actuator, or alternatively may be mechanical, such as a ratchet strap.

Pull-up cord 104 is typically made of polyester, though in military environments this may be replaced with nylon parachute cord. As true of normal packing procedures, pull-up cord 104 is routed through closing loop 108, which in turns extends from the bottom of the parachute container 109 and through the individual grommets of each of several intermediate pack tray flaps 107 (only one pack tray flap 107 is shown) and top grommet 106 of top pack tray flap 105.

Closing loop 108, illustratively made of webbing, is configured to close the bottom of the parachute container 109, and is fixed in place with metal closing pin 110. Once closing loop 108 and pull-up cord 104 are fully and appropriately routed, but prior to the placement of metal closing pin 110, pull-up cord 104 is tied to tensioning mechanism 102 by way of inner housing 103. Alternatively, pull-up cord 104 may be tied directly to tensioning mechanism 102, and then connected to inner housing 103 for purposes of lateral stability.

Tensioning mechanism 102 is actuated until a point when closing loop 108 extends past the top of the top pack tray flap 105; that is, the appropriate or tensioned position wherein an appropriate amount of tension is deemed to have been imparted to the parachute main closing loop since the appropriate tensioned position has been reached.

In some embodiments, the design of the parachute and its components are such that at the point where the closing loop 108 is extending past the top of the top pack tray flap 105 there is deemed to be an appropriate amount of tension imparted to the parachute main closing loop. That is, achieving the appropriate tensioned position is itself indicative of a successful tensioning of the closing loop.

In some embodiments, the amount of tension may be specifically measured or adapted to by the tensioning mechanism 102, such as where an amount of tensioning is applied such that the parachute components are not only arranged properly (e.g., closing loop 108 is extending past the top of the top pack tray flap 105), but that the amount of tensioning (e.g., force) required to place the parachute components in the proper arrangement or tensioned position is within an appropriate and/or predetermined range. In this manner, the positioning of the components with more or less force than expected may be used as an indication that some other problem with the packing of the parachute may exist. That is, achieving the appropriate tensioned position in addition to the applied tension being within a specific tensioning range is indicative of a successful tensioning of the closing loop 108.

A further advantage of the proposed invention is the now vertical extension of the closing loop, which aids in the insertion of closing loop pin 110.

In various embodiments, one or more interfaces are provided so as to reduce wear and tear on parachute components. For example, as shown in FIG. 1, an optional interface 120 may be provided between the housing 101 and top pack tray flap 105. This interface 120 may comprise a foam material, padding material, or other material that is useful in reducing wear and tear on, illustratively, the top pack tray flap 105 and/or other components of the parachute. It is noted that the interface 120 includes apertures and the like to allow for the unimpeded passing therethrough of the closing loop 108 and/or other elements as discussed herein.

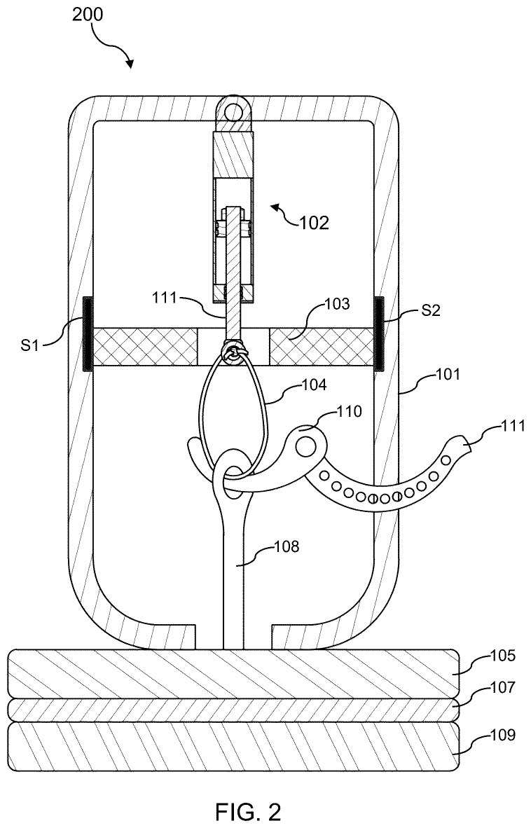

FIG. 2 illustrates an assembled parachute pack tray environment and tensioning system, in accordance with an embodiment of the present invention. Specifically, FIG. 2 depicts the parachute pack tray environment and tensioning system 100 of FIG. 1, but in an assembled state. The assembled parachute pack tray environment and tensioning system 200 of FIG. 2 depicts the closing loop 108 extended vertically through the container pack tray and closing pin 110 inserted.

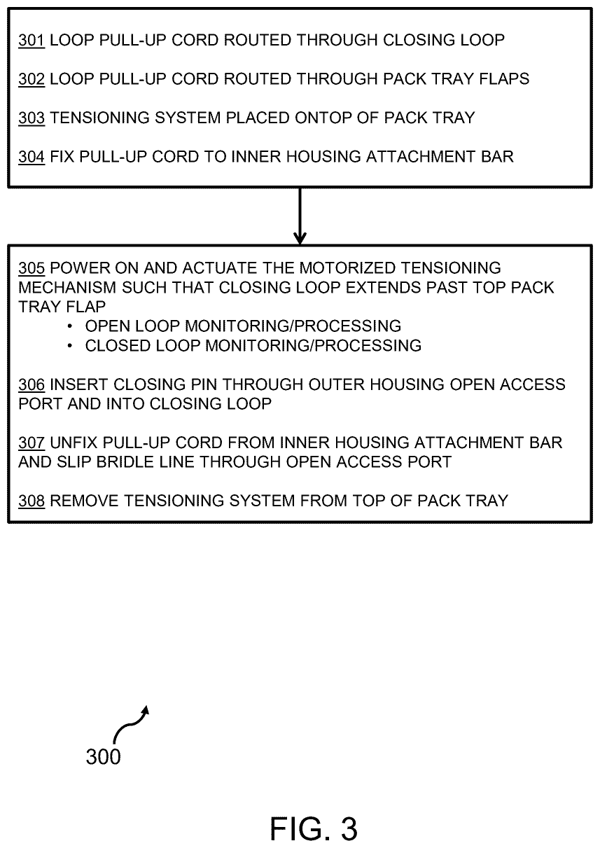

FIG. 3 depicts a flow diagram of a method of using a motorized tensioning system to route a closing loop through main pack tray flaps, in accordance with an embodiment of the present invention.

At step 301, pull-up cord 104 is looped through closing loop 108.

At step 302, pull-up cord 104 is routed through the grommets of each pack tray flap 107 in accordance with the parachute manufacturer's specifications.

At step 303, the tensioning system 100 is placed on top of the parachute container 109 (i.e., above the top pack tray flap grommet 106).

At step 304, the pull-cord 104 is fixed to the inner housing attachment bar 103, which is in turn connected to the motorized tensioning mechanism 102.

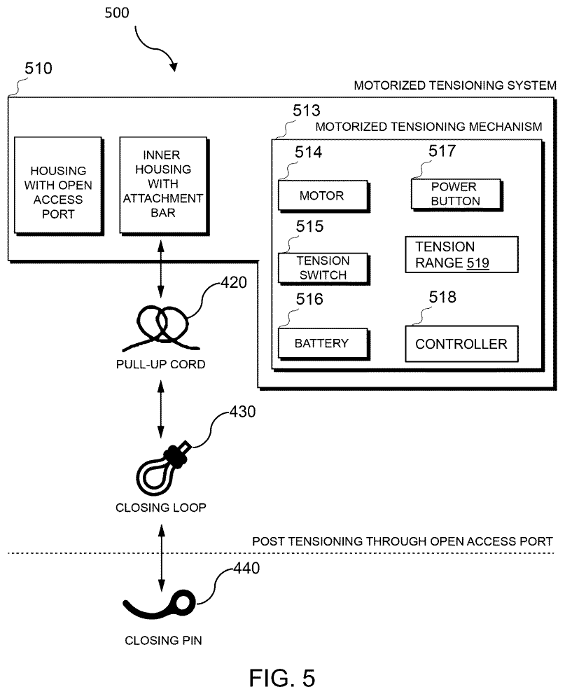

At step 305, the motorized tensioning mechanism 102 is powered on (e.g., via a power-on button) such that the motorized tensioning mechanism slowly applies an upwards force to the closing loop 108 by way of pull-up cord 104. As will be discussed below with respect to FIG. 5, various embodiments monitor the amount of force applied to the closing loop 108 to determine whether the applied force displacing or causing the closing loop to extend past the top pack tray flap is within an appropriate or expected range.

If the force applied to provide the necessary displacement of the closing loop to extend past the top pack tray flap is too great (i.e., greater than the appropriate range), then damage to the parachute or components thereof may have occurred during the packing process such that a safety inspection is warranted.

If the force applied to provide the necessary displacement of the closing loop to extend past the top pack tray flap is too small (i.e., less than the appropriate range), then a parachute or component thereof may have failed or been improperly routed or folded during the packing process such that a safety inspection is warranted.

Once the closing loop 108 extends past the top pack tray flap 105, a two-way switch is released, holding the closing loop 108 in its current position so that closing loop pin 110 may be inserted at step 306. After closing loop pin 110 insertion, the two-way switch may be actuated in the opposite direction, releasing tension on closing loop 108.

At step 307, the pull-up cord 104 is untied from the inner housing attachment bar 103, and bridle line 111 slips through the open access port 112.

At step 308, the tensioning system may then be removed from the top of the pack tray, completing the tensioning process.

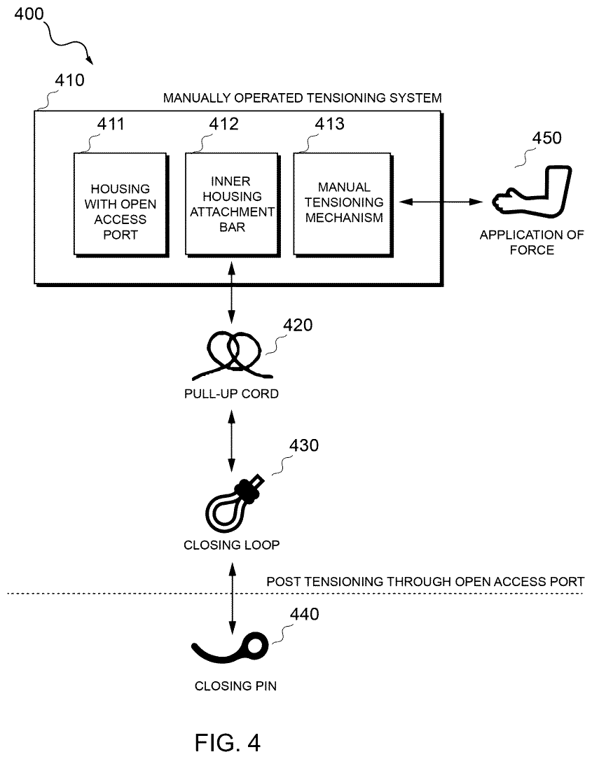

FIG. 4 depicts the components of a manually operated tensioning system, in accordance with an embodiment of the present invention. Specifically, FIG. 4 depicts a block diagram 400 visualizing the components of a system surrounding manually operated tensioning system 410. As depicted, manually operated tensioning system 410 comprise an housing 101 with an open access port 411, inner housing attachment bar 412, and a manual tensioning mechanism 413. Manual tensioning mechanism 413 is configured to enable tensioning via a manual application of force 450. Examples of manual tensioning mechanisms include a ratcheting system with a round gear or linear rack and pawl, a cam buckle, and so on. Manually operated tensioning system 410 integrates with pull-up cord 420, closing 430, and closing pin 440, as discussed above with respect to FIGS. 1-3.

FIG. 5 depicts the components of a motorized tensioning system, in accordance with an embodiment of the present invention. Specifically, FIG. 5 depicts a block diagram 500 visualizing the components of a system associated with a motorized tensioning system 510. Much like FIG. 4, FIG. 5 depicts a pull-up cord 420, closing loop 430, and closing pin 440 that remain the same in both form and function, as does the housing 101 with open access port 112 and inner housing attachment bar 103. Motorized tensioning mechanism 513 features more complexity than manual tensioning mechanism 513, and includes subcomponents such as a motor 514, power button 517, tension switch(es) 515, controller 518, and battery 516.

Motor 514 may be a micro linear actuator with a stepper motor, or any other motor or motorized module capable of developing sufficient force to implement the tensioning functions discussed herein. Power button 517 may be a rocker switch, push button, or similar designed to provide electrical power to the internal circuit of the motorized tensioning mechanism. Battery 516 may be an internal battery whose electrical specifications are designed to support the various components of motorized tensioning mechanism 513.

Tension switch(es) 515 may comprise one or more switches or control inputs configured to activate tension on (tighten pull-up cord) and tension off (loosen pull-up cord) functions, such as a two-way switch for providing tension on, and releasing tension from, the pull-up cord via control of the motor 514 in accordance with any control signals provided by the controller 518. In various embodiments, when tension switch 515 is not actively being actuated, the current position of the pull-up cord, and thus closing loop, is held constant (i.e., tension is not increased or reduced).

In various embodiments, the motor 514 and controller 518 are configured to determine the amount of tension (e.g., force) imparted to the pull-up cord and indicate a potential packing problem if such amount of tensioning is more or less than expected so as to indicate to an operator that a problem with the packing of the parachute may exist.

In various embodiments, a tension range indication and/or measurement device 519 is used to measure the amount of tension or displacement force imparted to the pull-up cord and/or indicate whether the tension imparted thereto is within a predetermined or programed range indicative of proper tensioning of the pull-up cord (alternatively indicating improper tensioning of the pull-up cord).

Various factors affect the amount of tension (displacement force) necessary or appropriate to cause the closing loop to extend past the top pack tray flap (step 305 of the method 300 of FIG. 3), such as age, type, manufacturer, and/or other factors associated with the component materials used for the parachute, the type or configuration of the parachute, variations in packing styles, and so on. Generally speaking, if packing a particular parachute/configuration requires, illustratively, 70-80 pounds of displacement force to cause the closing loop to extend past the top pack tray flap, then the predetermined or programed range indicative of proper tensioning of the pull-up cord may be set to 70-80 pounds (optionally 70-80 pounds +/− some percentage such as 5 or 10%, or some fixed amount such as 5 or 10 pounds) for that parachute/configuration. Other ranges may be appropriate for other parachute/configurations, such as 60-80 pounds, 70-90 pounds, 80-90 pounds and so on.

In embodiments with a controller 518 operating in an open loop, the motor 514 is caused to deliver an increasing amount of displacement force to the closing loop so as to extend the closing loop past the top pack tray flap. If the amount of displacement force measured after extending the closing loop past the top pack tray flap is outside of the appropriate range (e.g., too high or too low), then a warning may be generated to trigger a safety inspection.

In embodiments with a controller 518 operating in a closed loop, the motor 514 is caused to deliver an increasing amount of displacement force to the closing loop while measuring the displacement force delivered thereto so as to extend the closing loop past the top pack tray flap. If the amount of displacement force measured during this process exceeds the appropriate range (too high) then the process is stopped and a warning may be generated to trigger a repacking or restart of the process.

Controller 518 may consist of any combination of computing and/or logical circuitry capable of processing digital and other information in accordance with the various embodiments. Specifically, various embodiments contemplate that controller 518 comprises a processor, memory, input/output circuitry, and other circuitry suitable for operating with the other elements of the motorized tensioning mechanism 513 as discussed herein. For example, computer instructions associated with a function of an element of an embodiment or portion thereof are loaded into a respective memory and executed by a respective processor to implement the respective functions as discussed herein.

Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

It will be appreciated that the functions depicted and described herein may be implemented in hardware (e.g., as circuitry that cooperates with a processor to perform various processes/methods according to the various embodiments) and/or in a combination of software and hardware and/or any other hardware equivalents configured by computer code executed thereby or therein to perform the various processes/methods according to the various embodiments, such as using a general purpose computer, one or more application specific integrated circuits (ASIC), field programmable gate arrays (FPGAs), graphics processing units (GPUs), data processing units (DPUs), and/or other digital or analog processing devices.

In one embodiment, processes/methods according to the various embodiments are implemented in computer code that is loaded into memory and executed by one or more processors to implement the functions as discussed herein. Thus, the processes/methods of the various embodiments (including associated data structures) can be stored on a computer readable storage medium, e.g., RAM or other semiconductor-based memory, magnetic or optical drive or diskette, and the like. It will be appreciated that a general purpose computing device may be used to provide a general architecture and functionality suitable for implementing functional elements described herein or portions of the functional elements described herein.

Various modifications may be made to the systems, methods, apparatus, mechanisms, techniques and portions thereof described herein with respect to the various figures, such modifications being contemplated as being within the scope of the invention.

For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

1. A tensioning system configured for tensioning a parachute closing loop during packing a parachute, the tensioning system comprising:
a rigid housing with an open access port configured to enable removal of a parachute bridle line after insertion of a closing pin through a tensioned parachute closing loop;
a motorized tensioning mechanism configured for applying tension to the parachute closing loop so as to pull the parachute closing loop through one or more flaps of a parachute pack tray; and
an inner housing with an attachment bar to connect a pull-up cord routed through the closing loop to the motorized tensioning mechanism, wherein the inner housing is formed of one or more of a rigid plastic and a metal;
wherein the parachute closing loop extending past a top of a top pack tray flap indicates an appropriate tensioning of parachute closing loop;
wherein the motorized tensioning mechanism comprises a means for indicating whether an amount of tension imparted to the parachute closing loop is above or below the appropriate tensioning, and wherein the means for indicating comprises a warning generated in response to the amount of tension imparted to the parachute closing loop above or below the appropriate tensioning.

2. The tensioning system of claim 1, wherein appropriate tensioning of the parachute closing loop further comprises a determination that the amount of tension imparted to the parachute closing loop is within the appropriate tensioning.

3. (canceled)

4. The tensioning system of claim 1, further comprising an interface between an outer portion of the rigid housing and the parachute pack tray, the interface comprising a material configured to reduce wear of the parachute pack tray.

5. The tensioning system of claim 1, wherein the motorized tensioning mechanism comprises one of a ratcheting system and a cam buckle system.

6. (canceled)

7. The tensioning system of claim 1, wherein the motorized tensioning mechanism comprises a micro linear actuator with a stepper motor.

8. (canceled)

9. (canceled)

10. (canceled)

11. A method for tensioning a parachute closing loop during parachute packing, a pull-up cord being routed through the parachute closing loop and through flaps of a parachute pack tray and attached to an attachment bar on an inner housing of a tensioning system, the method comprising:
tensioning the pull-up cord and connected parachute closing loop using a motorized tensioning mechanism associated with the tensioning system until the parachute closing loop extends past a corresponding aperture of a top flap of the parachute pack tray;
wherein the parachute closing loop extending past the top flap of the parachute pack tray flaps indicates an appropriate tensioning of parachute closing loop and wherein the outer housing of the tensioning system is formed of one or more of a rigid plastic and a metal; and
wherein the motorized tensioning mechanism indicates whether an amount of tension imparted to the parachute closing loop is within the appropriate tensioning by generating a warning in response to the amount of tension imparted to the parachute closing loop above or below the appropriate tensioning.

12. The method of claim 11, wherein appropriate tensioning of the parachute closing loop further comprises a determination that the amount of tension imparted to the parachute closing loop is within the appropriate tensioning.

13. The method of claim 11, further comprising:
inserting a closing pin with an attached bridle line into the parachute closing loop;
disconnecting the pull-up cord from the parachute closing loop;
sliding the bridle line through an open access port on an outer housing of the tensioning system; and
removing the tensioning system from atop a grommet of the top flap of the parachute pack tray.

14. (canceled)

15. The method of claim 11, wherein an interface between an outer portion of an outer housing and the parachute pack tray is formed of a material configured to reduce wear of the parachute pack tray.

16. The method of claim 11, wherein the motorized tensioning mechanism comprises one of a ratcheting system and a cam buckle system.

17. The method of claim 11, wherein the motorized tensioning mechanism comprises a micro linear actuator with a stepper motor.

18. (canceled)

19. (canceled)

20. (canceled)
